(19) United States
(12) Patent Application Publication
(10) Pub. No.: US 2023/0396716 A1
(43) Pub. Date: Dec. 7, 2023

(54) IMAGE FORMING SYSTEM AND INSPECTION APPARATUS

(71) Applicant: CANON KABUSHIKI KAISHA, Tokyo (JP)

(72) Inventor: HIROYUKI EDA, Ibaraki (JP)

(21) Appl. No.: 18/324,888

(22) Filed: May 26, 2023

(30) Foreign Application Priority Data
Jun. 1, 2022 (JP) 2022-089387

(51) Int. Cl. H04N 1/00

(52) U.S. Cl. CPC H04N 1/00029; H04N 1/00092

(57) ABSTRACT

An image forming system includes an image forming apparatus that forms an image on a sheet, an inspection apparatus that inspects an image on a sheet, a conveyance apparatus disposed between the image forming apparatus and the inspection apparatus and including a stack tray on which a sheet is to be stacked, and a control unit that performs a first inspection mode in which the sheet on which the image is formed by the image forming apparatus and which is discharged therefrom is conveyed to the inspection apparatus and inspected by the inspection apparatus and a second inspection mode in which the sheet stacked on the stack tray of the conveyance apparatus is conveyed to the inspection apparatus and inspected by the inspection apparatus. A number of sheets inspected by the inspection apparatus during a predetermined time is greater in the second inspection mode than in the first inspection mode.

### BACKGROUND

### Field of the Disclosure

The present disclosure relates to an image forming system including an inspection apparatus that inspects a sheet on which an image is formed, and the inspection apparatus.

### Description of the Related Art

In recent years, an image forming system for forming an image on a sheet has been known in which an inspection apparatus that inspects an image printed on a sheet is connected to a downstream side of an image forming apparatus. Japanese Patent Application Laid-Open No. 2004-20650 discusses an image forming system in which an image forming apparatus forms an image on a sheet and an inspection apparatus reads the image formed on the sheet, analyzes the read image, and determines whether the image on the sheet is normal. Hereinafter, an inspection method in which a sheet with an image formed thereon by an image forming apparatus connected to an inspection apparatus is inspected by the inspection apparatus will be referred to as an “inline inspection”.

An inspection method in which, unlike the inline inspection, a sheet is inspected by the inspection apparatus without image formation by the image forming apparatus is also known. This inspection method will be hereinafter referred to as an “offline inspection”.

The offline inspection enables inspection of a sheet with an image formed thereon in advance by another image forming apparatus. Japanese Patent Application Laid-Open No. 2020-98268 discusses an image forming system capable of performing the offline inspection in addition to the inline inspection. This enables a user to, in a case where an inspection apparatus is provided in some of a plurality of image forming systems owned by the user, inspect a sheet with an image formed thereon by an image forming system that does not include the inspection apparatus among the plurality of image forming systems.

Meanwhile, there is a case where, in an image forming system, the number of sheets processible by an image forming apparatus per predetermined time (which is referred to as productivity or throughput) is different from the number of sheets processible by an inspection apparatus per predetermined time. In this case, to optimize the operation of the entire image forming system, the inspection apparatus sometimes performs inspection processing in the inline inspection not at the maximum productivity but at productivity corresponding to the productivity of the image forming apparatus. If the inspection apparatus also inspects a sheet in the offline inspection at productivity similar to the productivity in the inline inspection, an issue arises that the productivity in the offline inspection decreases unnecessarily.

### SUMMARY

Embodiments of the present disclosure are directed to preventing a decrease in productivity of an image forming system capable of performing both an inline inspection and an offline inspection.

According to an aspect of the present disclosure, an image forming system includes an image forming apparatus configured to form an image on a sheet, an inspection apparatus configured to read an image on a sheet and inspect the read image, a conveyance apparatus disposed between the image forming apparatus and the inspection apparatus and including a stack tray on which a sheet is to be stacked, the conveyance apparatus being configured to convey the sheet discharged from the image forming apparatus and the sheet stacked on the stack tray to the inspection apparatus, and a control unit configured to perform a first inspection mode in which the sheet on which the image is formed by the image forming apparatus and which is discharged from the image forming apparatus is conveyed to the inspection apparatus and inspected by the inspection apparatus and a second inspection mode in which the sheet stacked on the stack tray of the conveyance apparatus is conveyed to the inspection apparatus and inspected by the inspection apparatus. A number of sheets inspected by the inspection apparatus during a predetermined time is greater in the second inspection mode than in the first inspection mode.

According to another aspect of the present disclosure, an inspection apparatus configured to read an image on a sheet and inspect the read image and connected downstream of an image forming apparatus configured to form an image on a sheet and a conveyance apparatus configured to convey a sheet includes a control unit configured to perform a first inspection mode in which the sheet on which the image is formed by the image forming apparatus and which is discharged from the image forming apparatus is conveyed to the inspection apparatus and inspected by the inspection apparatus and a second inspection mode in which a sheet stacked on a stack tray of the conveyance apparatus is conveyed to the inspection apparatus and inspected by the inspection apparatus. A number of sheets inspected by the inspection apparatus during a predetermined time is greater in the second inspection mode than in the first inspection mode.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of an image forming system.

FIG. 2 is a block diagram illustrating a system configuration of the image forming system.

FIG. 3 is a schematic cross-sectional diagram illustrating an image forming apparatus.

FIG. 4 is a diagram illustrating a screen that is displayed before a correct image is registered in an inspection apparatus.

FIG. 5 is a diagram illustrating a screen that is displayed in registering the correct image in the inspection apparatus.

FIG. 6 is a diagram illustrating a screen that is displayed while the inspection apparatus is reading the correct image.

FIG. 7 is a diagram illustrating a screen that is displayed after the inspection apparatus finishes reading the correct image.

FIG. 8 is a diagram illustrating a screen that is displayed in setting an inspection skip area.

FIG. 9 is a diagram illustrating a screen that is displayed in configuring inspection settings for the inspection apparatus.

FIG. 10 is a diagram illustrating a screen that is displayed in displaying results of an inspection by the inspection apparatus.

FIG. 11 is a diagram illustrating a screen that is displayed in a case where the inspection apparatus determines a sheet to be normal.

FIG. 12 is a diagram illustrating a screen that is displayed in a case where the inspection apparatus determines a sheet to be abnormal.

FIG. 13 is a diagram illustrating a screen that is displayed in selecting an inspection mode to be performed by the inspection apparatus.

FIG. 14 is a diagram illustrating a screen that is displayed in setting an operation mode of the image forming apparatus in an inline inspection.

FIG. 15 is a diagram illustrating a screen that is displayed in setting an operation mode of the image forming apparatus in an offline inspection.

FIGS. 16A and 16B are diagrams illustrating sheet discharge destinations in a purge-and-recovery mode.

FIGS. 17A and 17B are diagrams illustrating sheet discharge destinations in a purge mode.

FIGS. 18A and 18B are diagrams illustrating sheet discharge destinations in a shift mode.

FIGS. 19A and 19B are diagrams illustrating sheet discharge destinations in a log-only mode.

FIG. 20 is a flowchart illustrating control performed in a case where the image forming apparatus executes a job.

FIG. 21 is a flowchart illustrating control performed in a case where the inspection apparatus performs inspection processing.

FIG. 22 is a table illustrating productivity and conveyance speeds of the image forming apparatus.

### DESCRIPTION OF THE EMBODIMENTS

An exemplary embodiment of the present disclosure will be described in detail below with reference to the attached drawings. The exemplary embodiment described below is merely an example of implementation of the present disclosure and is not intended to limit the technical scope of the present disclosure.

### <Image Forming System>

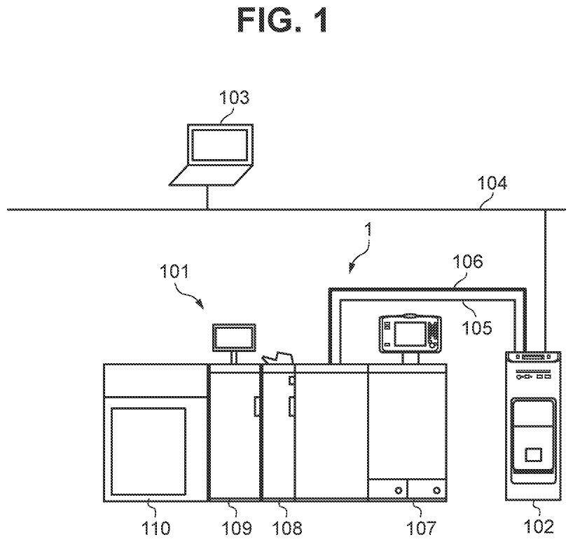

FIG. 1 illustrates an overall hardware configuration of an image forming system 1 according to the present exemplary embodiment. The image forming system 1 includes a printer 101 and an external controller 102. The printer 101 and the external controller 102 are communicably connected to each other via an internal local area network (LAN) 105 and a video cable 106. The external controller 102 is communicably connected to a client personal computer (PC) 103 via an external LAN 104, and print instructions are issued from the client PC 103 to the external controller 102.

A printer driver installed on the client PC 103 has a function of converting print data into a print description language processible by the external controller 102. A user who is to perform printing can issue print instructions from various applications via the printer driver. The printer driver transmits print data to the external controller 102 based on the print instructions from the user. The external controller 102 having received the print instructions from the client PC 103 performs data analysis and rasterization processing, submits print data to the printer 101, and issues print instructions to the printer 101.

The printer 101 includes a printing apparatus 107, an inserter 108, an inspection apparatus 109, and a large-capacity stacker 110. The printing apparatus 107 serving as an image forming apparatus forms an image on a sheet based on the instructions from the external controller 102. The inserter 108 serving as a conveyance apparatus inserts an insert sheet into a plurality of sheets conveyed from the printing apparatus 107. The inspection apparatus 109 serving as an inspection apparatus reads an image on a sheet conveyed from the inserter 108, compares the read image with a pre-registered correct image, and determines whether the image on the sheet is normal. The correct image is image data to be compared with an image on a sheet by the inspection apparatus 109 and is obtained in advance by the inspection apparatus 109 reading an image normally printed on a sheet. Alternatively, the correct image can be image data transmitted from the client PC 103. Hereinafter, a sheet determined to be normal by the inspection apparatus 109 will be referred to as a “normal sheet”, and a sheet determined to be abnormal by the inspection apparatus 109 will be referred to as an “abnormal sheet”. The large-capacity stacker 110 serving as a discharge apparatus stacks sheets conveyed from the inspection apparatus 109.

While the image forming system 1 according to the present exemplary embodiment has a configuration in which the external controller 102 is connected to the printer 101, the image forming system 1 is not limited to the configuration in which the external controller 102 is connected to the printer 101. More specifically, the printer 101 can be connected to the external LAN 104, and the client PC 103 can transmit print data processible by the printer 101 to the printer 101. In this case, the printer 101 performs data analysis and rasterization processing and performs printing.

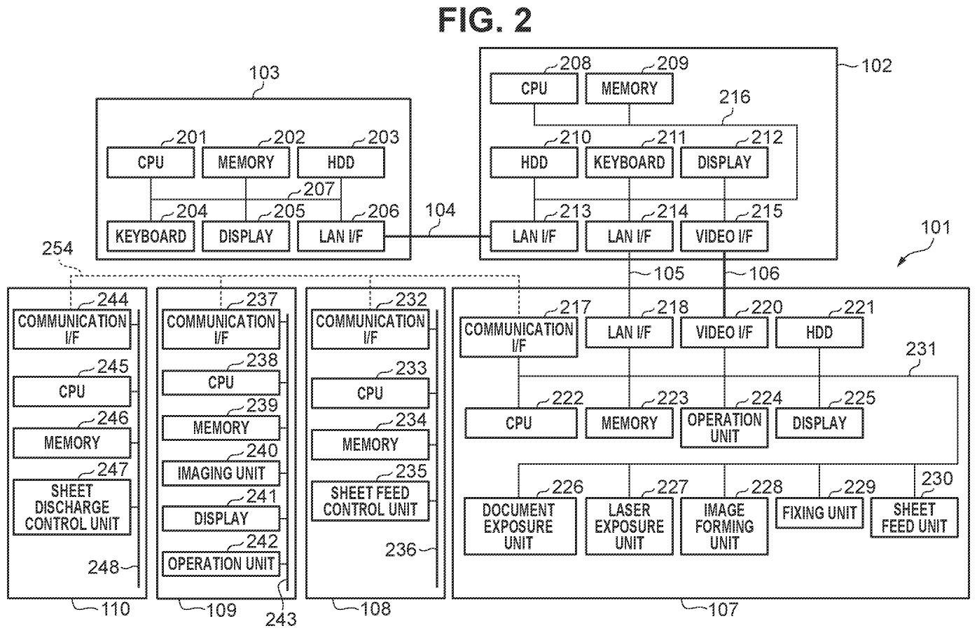

FIG. 2 is a block diagram illustrating a system configuration of the printer 101, the external controller 102, and the client PC 103. First, a configuration of the printing apparatus 107 will be described. The printing apparatus 107 includes a communication interface (I/F) 217, a LAN I/F 218, a video I/F 220, a hard disk drive (HDD) 221, a central processing unit (CPU) 222, a memory 223, an operation unit 224, and a display 225. The printing apparatus 107 also includes a document exposure unit 226, a laser exposure unit 227, an image forming unit 228, a fixing unit 229, and a sheet feed unit 230. The foregoing components of the printing apparatus 107 are connected via a system bus 231. The communication I/F 217 is connected to the inserter 108, the inspection apparatus 109, and the large-capacity stacker 110 via a communication cable 254 and performs communication for controlling the inserter 108, the inspection apparatus 109, and the large-capacity stacker 110. The LAN I/F 218 is connected to the external controller 102 via the internal LAN 105 and communicates print data between the printing apparatus 107 and the external controller 102. The video I/F 220 is connected to the external controller 102 via the video cable 106 and communicates image data between the printing apparatus 107 and the external controller 102.

The HDD 221 is a storage device storing programs and data. The CPU 222 comprehensively controls image processing and printing based on programs stored in the HDD 221. The memory 223 stores programs used by the CPU 222 to perform various kinds of processing and image data, and operates as a work area. The operation unit 224 receives inputs of various settings and operation instructions from the user. The display 225 displays settings information about the image forming system 1 and a print job processing status. The display 225 includes a touch panel operable by the user and functions as the operation unit 224.

The document exposure unit 226 performs processing of scanning in a document during a copy function or a scan function. More specifically, the document exposure unit 226 reads an image on a sheet placed by the user by imaging the sheet with a charge-coupled device (CCD) reading unit while illuminating the sheet with an exposure lamp. The laser exposure unit 227 is a device that performs primary charging for illuminating a photosensitive drum with laser light in order to transfer a toner image, and performs laser exposure. The laser exposure unit 227 first performs primary charging to charge a surface of the photosensitive drum to a uniform negative potential. The laser exposure unit 227 then illuminates the photosensitive drum with laser light using a laser driver while adjusting a reflection angle of the laser light using a polygon mirror. Consequently, an electrostatic latent image is formed on the photosensitive drum. The image forming unit 228 is a device for transferring toner to a sheet. The image forming unit 228 includes a development unit, a transfer unit, and a toner supply unit and transfers toner on the photosensitive drum to a sheet. The development unit applies negatively-charged toner from a development cylinder to the electrostatic latent image on the surface of the photosensitive drum and visualizes the electrostatic latent image. The transfer unit performs primary transfer to apply a positive potential to a primary transfer roller and transfer the toner on the surface of the photosensitive drum to an intermediate transfer belt 308 (described below). The transfer unit also performs secondary transfer to apply a positive potential to a secondary transfer external roller and transfer the toner on the intermediate transfer belt 308 to a sheet. The fixing unit 229 includes a first fixing unit 311 and a second fixing unit 313 which will be described below. The fixing unit 229 is a device for melting and fixing the toner on the sheet with heat and pressure and includes a heating heater, a fixing belt, and a pressing belt. The sheet feed unit 230 is a device for feeding sheets, and controls a sheet feed operation and a sheet conveyance operation using rollers and various sensors.

Next, a configuration of the inserter 108 will be described. The inserter 108 includes a communication OF 232, a CPU 233, a memory 234, and a sheet feed control unit 235, and the foregoing components are connected via a system bus 236. The communication OF 232 is connected to the printing apparatus 107 via the communication cable 254 and performs communication for controlling the inserter 108. The CPU 233 performs various types of control for sheet feeding based on control programs stored in the memory 234. The memory 234 is a storage device storing the control programs. The sheet feed control unit 235 controls a sheet feed unit of the inserter 108 and conveyance of sheets conveyed from the printing apparatus 107 while controlling rollers and sensors based on instructions from the CPU 233.

Next, a configuration of the inspection apparatus 109 will be described. The inspection apparatus 109 includes a communication OF 237, a CPU 238, a memory 239, an imaging unit 240, a display 241, and an operation unit 242, and the foregoing components are connected via a system bus 243. The communication OF 237 is connected to the printing apparatus 107 via the communication cable 254 and performs communication for controlling the inspection apparatus 109. The CPU 238 performs various types of control for inspection based on control programs stored in the memory 239. The memory 239 is a storage device storing the control programs. The imaging unit 240 includes reading units 331 and 332 (described below) and reads an image on a sheet conveyed to the inspection apparatus 109 based on an instruction from the CPU 238. The CPU 238 compares a printed image captured by the imaging unit 240 with a correct image stored in the memory 239 and determines whether the printed image is normal. The display 241 displays inspection results and settings screens. The operation unit 242 is operated by the user and receives instructions such as an instruction for changing a setting of the inspection apparatus 109 and an instruction for registering a correct image. The display 241 includes a touch panel operable by the user and functions as the operation unit 242.

Next, a configuration of the large-capacity stacker 110 will be described. The large-capacity stacker 110 includes a communication I/F 244, a CPU 245, a memory 246, and a sheet discharge control unit 247, and the foregoing components are connected via a system bus 248. The communication I/F 244 is connected to the printing apparatus 107 via the communication cable 254 and performs communication for controlling the large-capacity stacker 110. The CPU 245 performs various types of control for sheet discharge based on control programs stored in the memory 246. The memory 246 is a storage device storing the control programs. The sheet discharge control unit (the discharge control unit) 247 performs control to convey a sheet conveyed to the large-capacity stacker 110 to a stack tray 341 or an escape tray 346, which will be described below, based on an instruction from the CPU 245.

Next, a configuration of the external controller 102 will be described. The external controller 102 includes a CPU 208, a memory 209, a HDD 210, a keyboard 211, a display 212, LAN I/Fs 213 and 214, and a video I/F 215. The foregoing components of the external controller 102 are connected via a system bus 216. The CPU 208 comprehensively performs processing, such as receiving print data from the client PC 103, performing raster image processing (RIP), and transmitting print data to the printer 101, based on programs and data stored in the HDD 210. The memory 209 stores programs and data used by the CPU 208 to perform various kinds of processing, and operates as a work area. The HDD 210 stores programs and data for operations including printing processing. The keyboard 211 is a device for inputting operation instructions to the external controller 102. The display 212 displays information about an application executed by the external controller 102 based on a video signal of a still image or a moving image. The LAN OF 213 is connected to the client PC 103 via the external LAN 104 and communicates print instructions between the external controller 102 and the client PC 103. The LAN I/F 214 is connected to the printer 101 via the internal LAN 105 and communicates print instructions between the external controller 102 and the printer 101. The video OF 215 is connected to the printer 101 via the video cable 106 and communicates print data between the external controller 102 and the printer 101.

Next, a configuration of the client PC 103 will be described. The client PC 103 includes a CPU 201, a memory 202, a HDD 203, a keyboard 204, a display 205, and a LAN OF 206, and the foregoing components are connected via a system bus 207. The CPU 201 generates print data and performs print instructions based on a document processing program stored in the HDD 203. The CPU 201 comprehensively controls the devices connected to the system bus 207. The memory 202 stores programs and data used by the CPU 201 to perform various kinds of processing, and operates as a work area. The HDD 203 stores programs and data for operations including printing processing. The keyboard 204 is a device for inputting operation instructions to the client PC 103. The display 205 displays information about an application executed by the client PC 103 based on a video signal of a still image or a moving image. The LAN OF 206 is connected to the external controller 102 via the external LAN 104 and communicates print instructions between the client PC 103 and the external controller 102.

While the external controller 102 and the printer 101 are connected to each other via the internal LAN 105 and the video cable 106 in the above-described configuration, any configurations that enable transmission and reception of data for printing can be used. For example, a configuration in which only a video cable is connected can be used. Further, each of the memories 202, 209, 223, 234, 239, and 246 can be a storage device for storing data and programs. For example, a volatile random access memory (RAM), a non-volatile read-only memory (ROM), a built-in HDD, an external HDD, or a universal serial bus (USB) memory can be used instead.

### <Image Forming Apparatus>

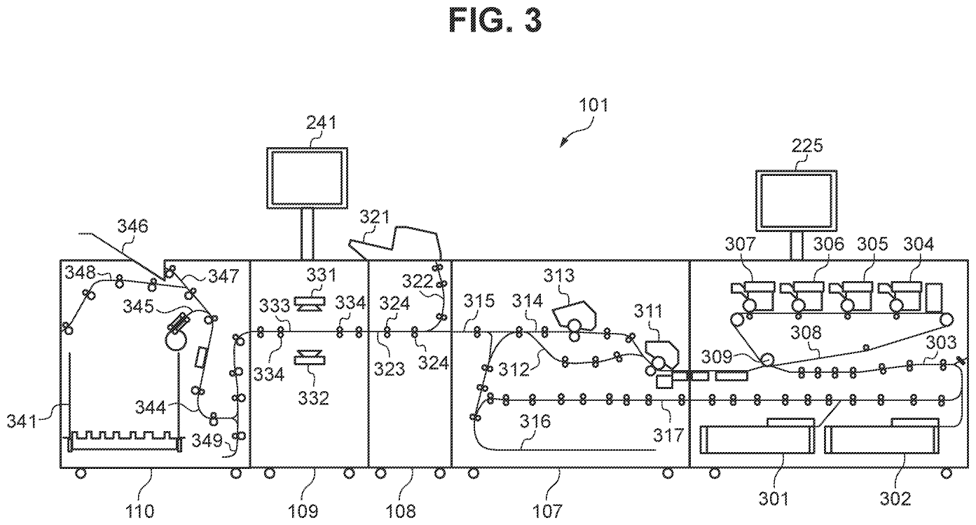

Next, the printer 101 will be described with reference to FIG. 3. FIG. 3 is a schematic cross-sectional diagram of the printer 101. The printing apparatus 107 includes sheet feed decks 301 and 302. The sheet feed decks 301 and 302 store various sheets. Each of the sheet feed decks 301 and 302 can separate an uppermost sheet from the plurality of sheets stored therein and convey the sheet to a sheet conveyance path 303. Development stations 304 to 307 included in the image forming unit 228 form toner images using color toners of yellow (Y), magenta (M), cyan (C), and black (Bk), respectively, in order to form a color image. The toner images formed by the development stations 304 to 307 are primarily transferred to the intermediate transfer belt 308. The intermediate transfer belt 308 is rotated to transfer the toner images to the sheet conveyed from the sheet conveyance path 303 at a secondary transfer position 309. The display 225 displays a printing status of the printer 101 and information for settings of the printer 101. The first fixing unit 311 includes a pressing roller and a heating roller. While passing the sheet between the pressing roller and the heating roller, the first fixing unit 311 melts and presses the toner to fix the toner images to the sheet. The sheet having passed through the first fixing unit 311 is conveyed to the inserter 108 via a sheet conveyance path 312 and a sheet conveyance path 315. The toner may be additionally melted and pressed to fix the toner images depending on the type of sheet. In this case, the sheet having passed through the first fixing unit 311 is conveyed to the second fixing unit 313 via an upper sheet conveyance path, and additional melting and pressing is performed on the sheet. The sheet is then conveyed to the inserter 108 via a sheet conveyance path 314 and the sheet conveyance path 315.

In a case where images are to be formed on both sides of the sheet, the sheet is reversed in a sheet reversal path 316 and then conveyed to a duplex conveyance path 317, and an image is transferred onto the second side of the sheet at the secondary transfer position 309.

The inserter 108 can insert an insert sheet into a plurality of sheets conveyed from the printing apparatus 107. The inserter 108 includes an inserter tray 321 and a plurality of conveyance roller pairs 324. The inserter tray 321 is a stack tray for stacking sheets. The inserter 108 feeds an insert sheet from the inserter tray 321 and conveys the insert sheet to a sheet conveyance path 323 via a sheet conveyance path 322. In this manner, the inserter 108 can insert the insert sheet into a group of sheets conveyed from the printing apparatus 107 at a given position and conveys the sheets including the insert sheet to the subsequent apparatus (the inspection apparatus 109). The inserter 108 can also convey a sheet to the inspection apparatus 109 independently from a printing operation of the printing apparatus 107 by feeding the sheet from the inserter tray 321. In other words, the inserter 108 can convey, to the inspection apparatus 109, a sheet subjected to image formation and discharged by the printing apparatus 107 and a sheet different from the sheet subjected to image formation and discharged by the printing apparatus 107.

The inspection apparatus 109 reads an image on a sheet conveyed from the inserter 108 while conveying the sheet using a plurality of conveyance roller pairs 334, and determines whether the image on the sheet is normal. In the inspection apparatus 109, the reading units 331 and 332 are arranged to face each other. The reading unit 331 reads an image on a first side (a front side) of the sheet, and the reading unit 332 reads an image on a second side (a back side) of the sheet that is opposite of the first side (the front side). At timing when the sheet being conveyed on a conveyance path 333 by the plurality of conveyance roller pairs 334 reaches a predetermined reading position, the inspection apparatus 109 reads the image(s) on the sheet using the reading unit 331 and/or the reading unit 332. The display 241 displays a result of an inspection performed by the inspection apparatus 109.

The large-capacity stacker 110 includes the stack tray 341 as a first discharge tray to which sheets are to be discharged. The large-capacity stacker 110 has a shift function of discharging a sheet to a position on the stack tray 341 that is shifted by a predetermined amount from a position of another sheet. The sheet having passed through the inspection apparatus 109 is conveyed to the large-capacity stacker 110 via a sheet conveyance path 344. The sheet conveyed to the large-capacity stacker 110 is conveyed from the sheet conveyance path 344 to the stack tray 341 via a sheet conveyance path 345 and stacked on the stack tray 341.

The large-capacity stacker 110 further includes the escape tray 346 as a second discharge tray to which a sheet is to be discharged. The escape tray 346 is a tray to which a sheet inspected and determined to be abnormal by the inspection apparatus 109, i.e., an abnormal sheet is to be discharged. The abnormal sheet to be discharged to the escape tray 346 is conveyed from the sheet conveyance path 344 to the escape tray 346 via a sheet conveyance path 347. In a case where a post-processing apparatus is connected to a downstream side of the large-capacity stacker 110, a sheet is conveyed to the post-processing apparatus via a sheet conveyance path 348. The large-capacity stacker 110 also includes a reversal portion 349 for reversing the front and back sides of a sheet. The reversal portion 349 is used to stack a sheet on the stack tray 341. In a case where the large-capacity stacker 110 is to convey a sheet to the escape tray 346 or the subsequent post-processing apparatus, the reversal operation at the reversal portion 349 is not performed.

In the present exemplary embodiment, the printer 101 can perform two inspection modes, an inline inspection (a first inspection mode) and an offline inspection (a second inspection mode). The inline inspection is a mode in which, while a print job is executed using the printing apparatus 107, a sheet on which an image is formed by the print job is conveyed to the inspection apparatus 109 and inspected. On the other hand, the offline inspection is a mode in which a sheet is conveyed from the inserter tray 321 to the inspection apparatus 109 and inspected instead of inspecting a sheet conveyed from the printing apparatus 107 to the inspection apparatus 109. In other words, the offline inspection is a mode in which the printer 101 inspects a sheet without printing by the printing apparatus 107. The printer 101 can also perform a print mode in which the printing by the printing apparatus 107 is performed and the inspection by the inspection apparatus 109 is not performed.

In the inline inspection, the printer 101 feeds a sheet from the sheet feed deck 301 or 302, and causes the printing apparatus 107 to form an image on the sheet. The printer 101 then conveys the sheet to the inspection apparatus 109 via the sheet conveyance path 323 and reads the image on the sheet. In this manner, the printer 101 can sequentially inspect sheets on which images are formed by the printing apparatus 107.

In the offline inspection, the printer 101 feeds a sheet from the inserter tray 321 of the inserter 108. The printer 101 then conveys the sheet to the inspection apparatus 109 via the sheet conveyance path 323 and reads an image on the sheet. In this manner, the printer 101 can also inspect a sheet subjected to printing by a printing apparatus other than the printing apparatus 107. The sheet to be inspected by the inspection apparatus 109 in the offline inspection can also be a sheet placed on the inserter 108 by a user after the sheet is subjected to image formation by the printing apparatus 107 and is discharged to the large-capacity stacker 110.

### <Operations of Inspection Apparatus>

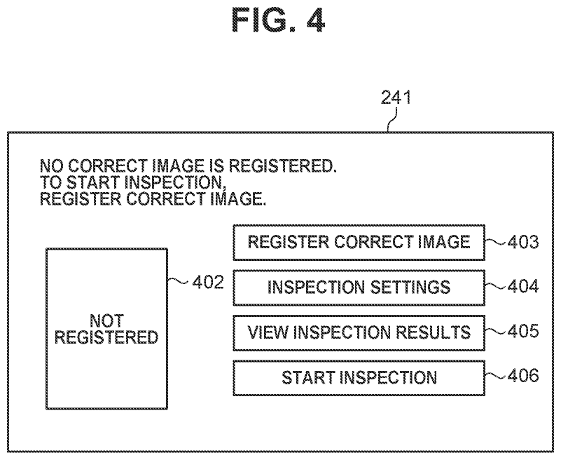

FIGS. 4 to 12 illustrate examples of a screen displayed on the display 241 of the inspection apparatus 109. The inspection apparatus 109 inspects an image on a sheet conveyed to the inspection apparatus 109 based on preset inspection items. The inspection apparatus 109 inspects an image on the sheet by comparing a correct image registered in advance in the memory 239 and an image (a read image) obtained by reading the image on the sheet using the reading unit 331 or 332. Methods for comparing the correct image and the read image include a method of comparing a pixel value at each image position between the images, a method of comparing object positions using edge detection, and a method of extracting text data using optical character recognition (OCR). The inspection items include print position misalignment, image colors, image density, streaking or blurring, and omission in printing.

FIG. 4 illustrates an example of a display screen that is displayed on the display 241 of the inspection apparatus 109 during startup of the inspection apparatus 109. In FIG. 4, the display screen on the display 241 displays a message indicating that no correct image is registered and the user is to register a correct image in order to start an inspection. In a case where a correct image has already been registered, a message indicating that an inspection can be started is displayed. In this case, the registered correct image is displayed in an image display section 402 of the display 241. In the example of FIG. 4, a message indicating that no correct image is registered is displayed in the image display section 402. A button 403 is used to call a correct image registration screen. A button 404 is used to call an inspection settings screen. A button 405 is used to call an inspection results view screen. A button 406 is used to issue an instruction to start an inspection.

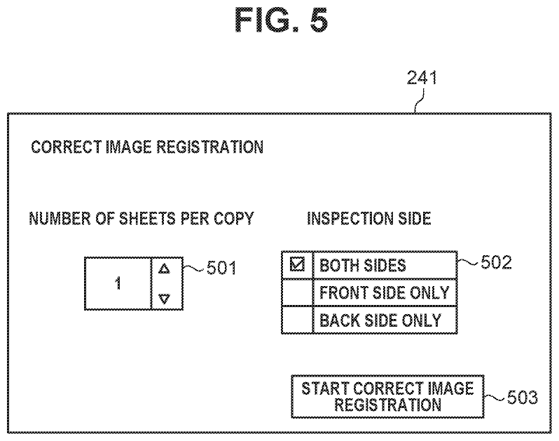

FIG. 5 illustrates an example of a display screen that is displayed on the display 241 of the inspection apparatus 109 when the user registers a correct image. The display screen illustrated in FIG. 5 is displayed on the display 241 when the button 403 in FIG. 4 is selected. A number-of-sheets setting section 501 is used to set the number of sheets per copy in an inspection target job (an inspection job). In a case where the number of sheets per copy in the inspection job is two or more, a plurality of images can be registered as correct images in the inspection apparatus 109. A side setting section 502 is used to select which side of a sheet the inspection apparatus 109 is to inspect. The user can select whether to inspect images on both sides of a sheet, an image on the front side only, or an image on the back side only via the side setting section 502. Even in a case where an image is printed on one side of a sheet, the setting to inspect both sides of the sheet can be selected in order to check whether dust is on the side other than the print side. A button 503 is used to issue an instruction to register a correct image. When the button 503 is selected, the inspection apparatus 109 reads an image on a conveyed sheet and registers image data of the read image as a correct image.

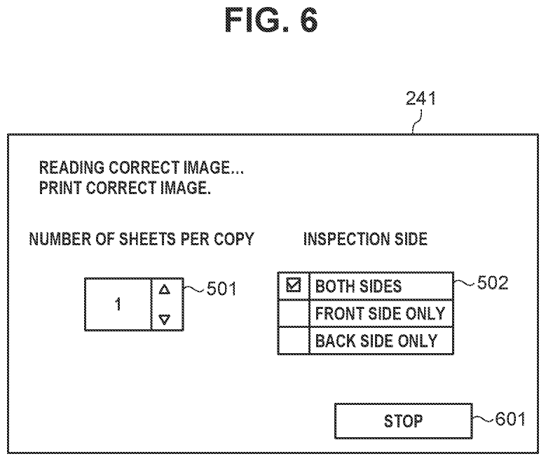

FIG. 6 illustrates an example of a display screen that is displayed on the display 241 while the inspection apparatus 109 is reading an image on a sheet to register a correct image. The screen illustrated in FIG. 6 is displayed when the button 503 in FIG. 5 is selected. A button 601 is used to issue a reading stop instruction. When the button 601 is selected, the inspection apparatus 109 stops reading the image, and the display 241 returns to the display screen in FIG. 4.

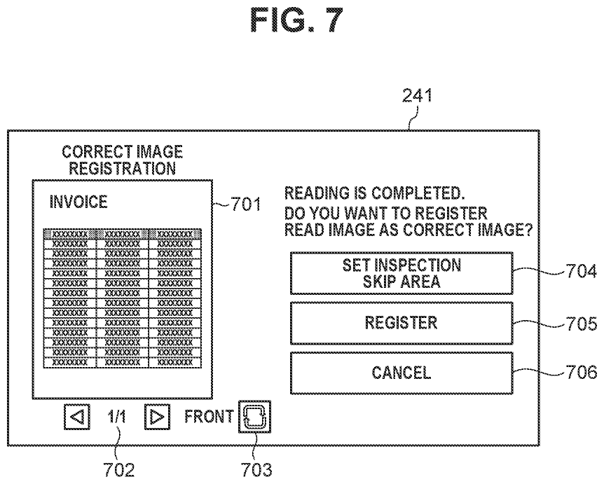

FIG. 7 illustrates an example of a display screen that is displayed on the display 241 after the reading of the correct image is completed. An image display section 701 displays the image of the sheet read by the inspection apparatus 109. In a case where there is a plurality of images, the displayed image can be switched using a switching button 702. In a case where both sides of a sheet are to be inspected, the displayed image can be switched between images on the front and back sides using a switching button 703. A button 704 is used to issue an instruction to set an inspection skip area. An inspection skip area for which an inspection is to be skipped can be set for printing, such as variable data printing (VDP), in which print content in a specific area is changed for each copy. A button 705 is used to register the image displayed in the image display section 701 as a correct image. When the button 705 is selected, the inspection apparatus 109 registers the correct image and then returns to the display screen in FIG. 4. A button 706 is used to cancel the registration. When the button 706 is pressed, the inspection apparatus 109 does not register the correct image, and the display 241 returns to the display screen in FIG. 4.

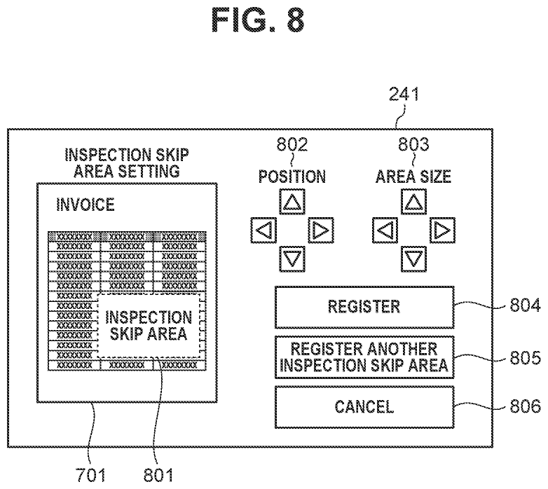

FIG. 8 illustrates an example of an inspection skip area setting screen that is displayed on the display 241. The display screen in FIG. 8 is displayed on the display 241 when the button 704 is selected. An area 801 indicates an inspection skip area. The user can change the position of the area 801 via a position setting section 802 and can change the size of the area 801 via a size setting section 803. A button 804 is used to register a setting for the inspection skip area. When the button 804 is selected, the inspection apparatus 109 registers the area 801 as the inspection skip area, and the display 241 returns to the display screen in FIG. 7. A button 805 is used to register another inspection skip area. This enables the inspection apparatus 109 to register a plurality of inspection skip areas for one piece of image data. A button 806 is used to cancel the setting for the inspection skip area.

When the button 806 is selected, the display 241 returns to the display screen in FIG. 7.

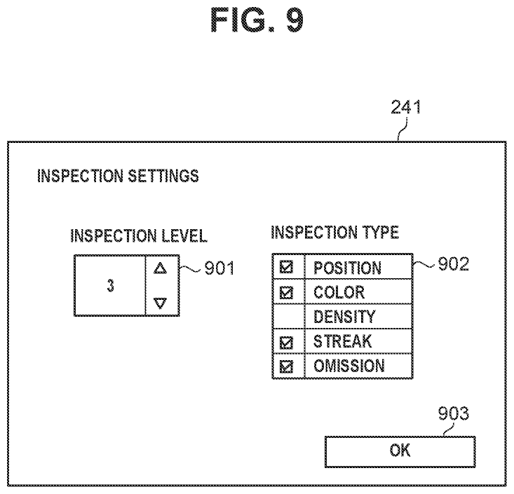

FIG. 9 illustrates an example of a settings screen for performing inspection settings. The display screen illustrated in FIG. 9 is displayed on the display 241 when the button 404 is selected. A level setting section 901 is used to set an inspection level. With a higher inspection level set via the level setting section 901, the inspection apparatus 109 determines a sheet to be abnormal based on a smaller difference between a correct image and a read image of the sheet. A type setting section 902 is used to set an inspection type. The user can set inspection items via the type setting section 902. In the type setting section 902 of the display screen illustrated in FIG. 9, “position”, “color”, “streak”, and “omission” are set as inspection items, whereas “density” is not set as an inspection item. A button 903 is used to confirm the inspection settings. When the button 903 is selected, the inspection apparatus 109 registers the inspection settings, and the display 241 returns to the display screen in FIG. 4.

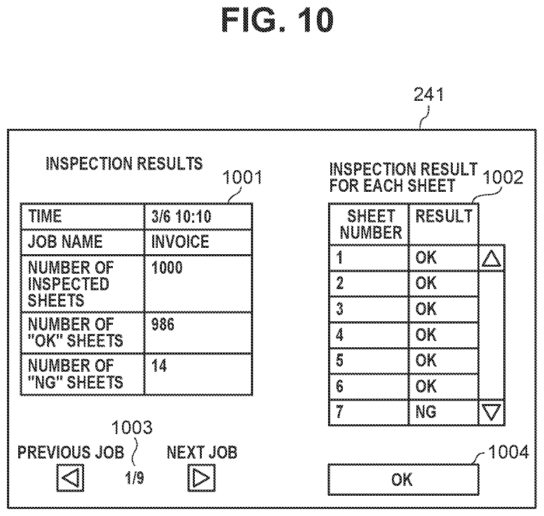

FIG. 10 illustrate an example of a display screen that displays inspection results. The display screen illustrated in FIG. 10 is displayed on the display 241 when the button 405 in FIG. 4 is selected. An attribute display section 1001 displays attributes of an inspection job and inspection results. A result display section 1002 displays an inspection result for each sheet. A “result” column in the result display section 1002 indicates “OK” in a case where a sheet on which an image is read by the inspection apparatus 109 is determined to be normal, and indicates “NG” in a case where a sheet on which an image is read by the inspection apparatus 109 is determined to be abnormal. A job selection section 1003 is used to select a job as an inspection results display target. The display screen illustrated in FIG. 10 displays inspection results of a first job among nine jobs stored in the inspection apparatus 109. By operating a right or left button of the job selection section 1003, the user can switch the job for which inspection results are displayed on the display 241. A button 1004 is used to issue an instruction to end the display of the inspection results. When the button 1004 is selected, the display 241 returns to the display screen in FIG. 4.

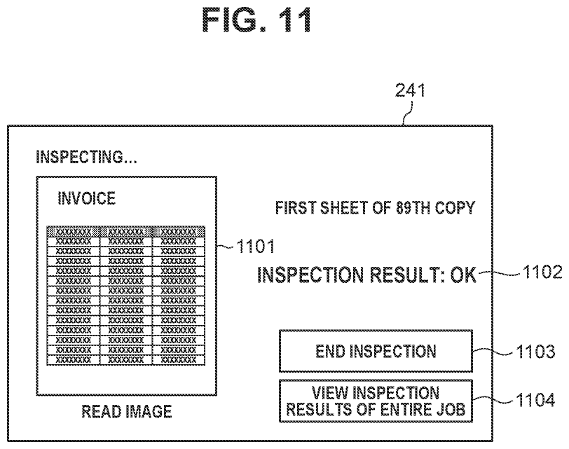

FIG. 11 illustrates an example of a display screen that is displayed on the display 241 during inspection by the inspection apparatus 109. The screen illustrated in FIG. 11 is displayed when the button 406 in FIG. 4 is selected. An image display section 1101 displays a read image of a sheet inspected by the inspection apparatus 109. A result display section 1102 displays an inspection result obtained by comparing the read image displayed in the image display section 1101 and a correct image. On the screen illustrated in FIG. 11, the result display section 1102 displays “OK” because the sheet on which the image is read by the inspection apparatus 109 is determined to be normal. A button 1103 is used to issue an instruction to end the inspection. When the button 1103 is selected, the inspection apparatus 109 ends the inspection processing, and the display 241 returns to the display screen in FIG. 4. A button 1104 is used to issue an instruction to display a screen for viewing inspection results of the entire job. When the button 1104 is selected, the display screen in FIG. 10 is displayed on the display 241.

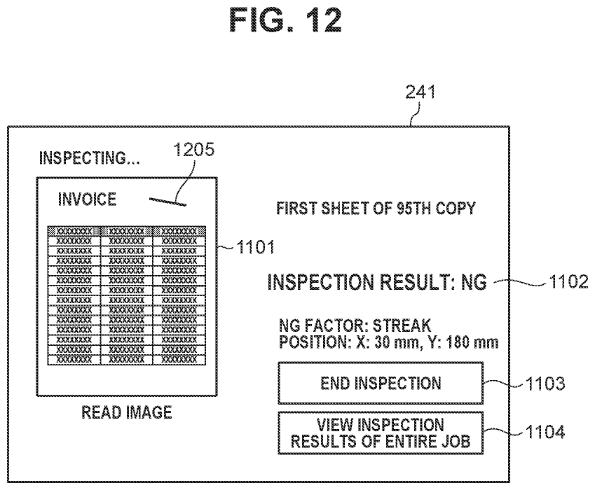

FIG. 12 illustrates an example of a display screen that is displayed in a case where an image on a sheet read by the inspection apparatus 109 is determined to be abnormal. In the example illustrated in FIG. 12, a streak 1205 is detected from the image of the sheet read by the inspection apparatus 109, and thus the result display section 1102 displays “NG”.

### <Inspection Mode Setting>

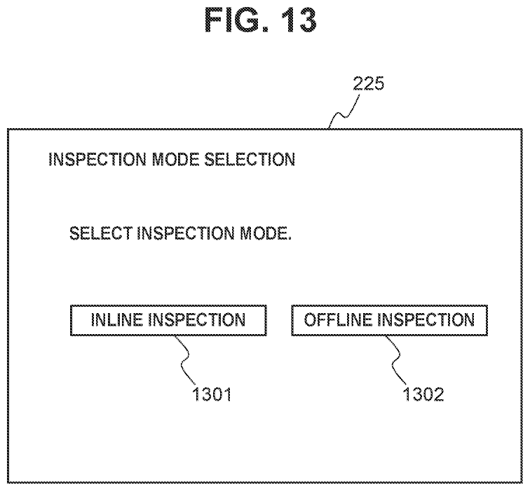

Next, a method for setting the inspection mode of the printer 101 will be described with reference to FIGS. 13 to 15. FIG. 13 illustrates an example of an inspection mode selection screen that is displayed on the display 225. The display screen illustrated in FIG. 13 is displayed on the display 225 when the user performs a predetermined operation on the display 225 (the operation unit 224). As described above, the printer 101 can perform two inspection modes, i.e., the inline inspection and the offline inspection. The user selects the inspection mode to be performed by the printer 101 via the inspection mode selection screen. A button 1301 is used to select the inline inspection, and a button 1302 is used to select the offline inspection.

The inline inspection can be set also via a print job setting screen. The offline inspection can be set also via a screen for setting a job type such as a print job or a scan job.

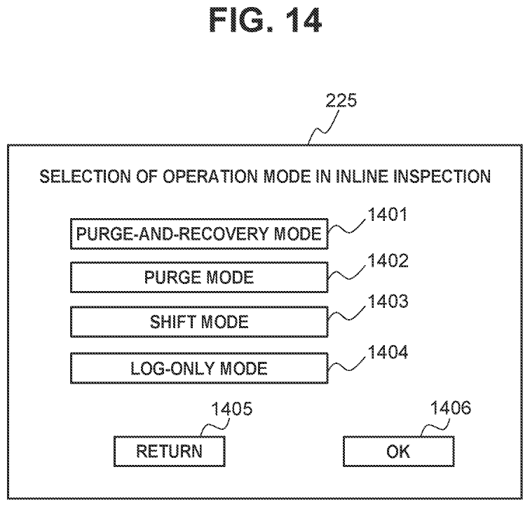

FIG. 14 illustrates an example of a setting screen for setting an operation of the printer 101 at the time of abnormal sheet detection in the inline inspection. The display screen illustrated in FIG. 14 is displayed on the display 225 when the button 1301 in FIG. 13 is selected. Operation modes that can be performed by the printer 101 in the inline inspection are a purge-and-recovery mode, a purge mode, a shift mode, and a log-only mode. The operation of the printer 101 in each of the operation modes will be described below. A button 1401 is used to select the purge-and-recovery mode. A button 1402 is used to select the purge mode. A button 1403 is used to select the shift mode. A button 1404 is used to select the log-only mode. A button 1405 is used to return the screen to the inspection mode selection screen. A button 1406 is used to set the operation of the printer 101 in the inline inspection. The user can set the operation of the printer 101 in the inline inspection by selecting the button 1406 with one of the buttons 1401 to 1404 selected.

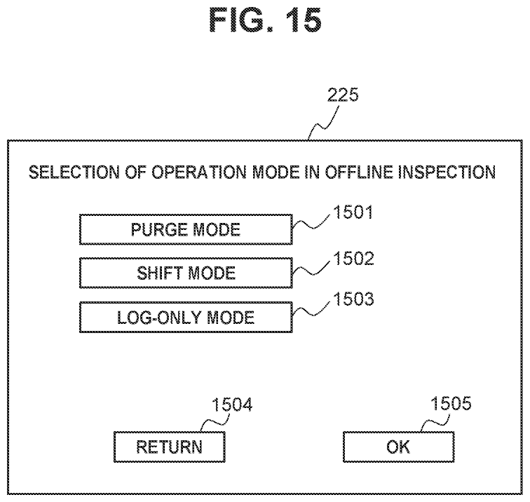

FIG. 15 illustrates an example of a setting screen for setting the operation of the printer 101 at the time of abnormal sheet detection in the offline inspection. The display screen illustrated in FIG. 15 is displayed on the display 225 when the button 1302 in FIG. 13 is selected. Operation modes that can be performed by the printer 101 in the offline inspection are the purge mode, the shift mode, and the log-only mode. In other words, the printer 101 is configured not to set the purge-and-recovery mode in the offline inspection. A button 1501 is used to select the purge mode. A button 1502 is used to select the shift mode. A button 1503 is used to select the log-only mode. A button 1504 is used to return the screen to the inspection mode selection screen. A button 1505 is used to set the operation of the printer 101 in the offline inspection. The user can set the operation of the printer 101 in the offline inspection by selecting the button 1505 with one of the buttons 1501 to 1503 selected.

While the inspection mode of the printer 101 is set using the operation unit 224 and the display 225 of the printing apparatus 107 in the present exemplary embodiment, the inspection mode of the printer 101 can be set using the external controller 102 or the client PC 103.

### <Operation at Detection of Abnormal Sheet>

Next, the operation of the printer 101 performed in a case where the inspection apparatus 109 detects an abnormal sheet will be described. A job in which the number of pages per copy is five will be described as an example.

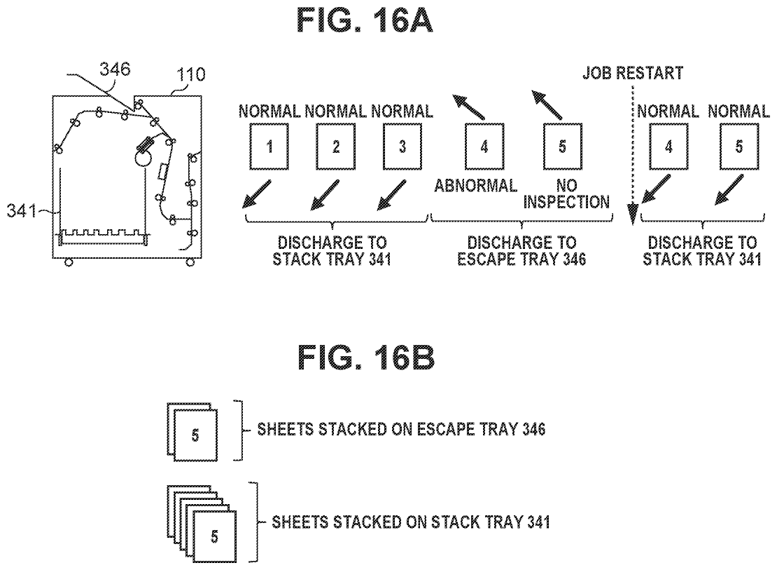

First, the operation of the printer 101 in the purge-and-recovery mode will be described with reference to FIGS. 16A and 16B. FIGS. 16A and 16B illustrate sheet discharge destinations in the purge-and-recovery mode. The purge-and-recovery mode is a mode in which, in a case where the inspection apparatus 109 determines a sheet to be abnormal, the abnormal sheet is discharged to a discharge unit different from a discharge unit for normal sheets, and an image printed on the abnormal sheet is reprinted on another sheet. The purge-and-recovery mode can be set in the inline inspection. As illustrated in FIG. 16A, the first to third sheets determined as normal sheets are discharged to the stack tray 341 in the purge-and-recovery mode. On the other hand, the fourth sheet determined as an abnormal sheet is discharged to the escape tray 346. The fifth sheet, which is a sheet following the abnormal sheet, is not inspected by the inspection apparatus 109 and is discharged to the escape tray 346 similarly to the abnormal sheet. After the abnormal sheet and the sheet following the abnormal sheet are discharged to the escape tray 346, the printer 101 reprints the image formed on the fourth sheet, which is the abnormal sheet, on the sixth sheet. The printer 101 further reprints the image formed on the fifth sheet, which is the sheet following the abnormal sheet, on the seventh sheet. The inspection apparatus 109 then inspects the sixth and seventh sheets on which the images are reprinted. In a case where the sheets on which the images are reprinted are determined as normal sheets, the sheets are discharged to the stack tray 341. Eventually, as illustrated in FIG. 16B, a print product of a complete set of pages 1 to 5 is stacked on the stack tray 341, and the abnormal sheet and the sheet following the abnormal sheet are stacked on the escape tray 346.

The foregoing processing in which an image formed on an abnormal sheet is reprinted on another sheet in a case where the abnormal sheet is detected is referred to as “recovery processing”. The foregoing processing in which an abnormal sheet is discharged to a discharge unit different from a discharge unit for normal sheets is referred to as “purge processing”. In other words, the purge-and-recovery mode is a mode in which the printer 101 performs both the purge processing and the recovery processing. In the purge-and-recovery mode, the printer 101 discharges the sheet following the abnormal sheet to the escape tray 346 without inspecting the sheet using the inspection apparatus 109. Thus, the pages of the print product after the recovery processing are in the correct order as illustrated in FIG. 16B.

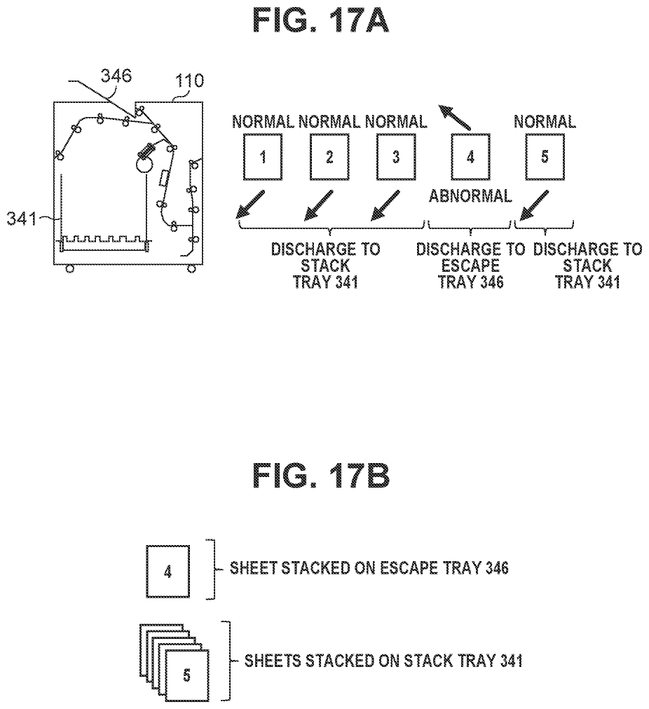

Next, the operation of the printer 101 in the purge mode will be described with reference to FIGS. 17A and 17B. FIGS. 17A and 17B illustrate sheet discharge destinations in the purge mode. The purge mode is a mode in which, in a case where the inspection apparatus 109 determines a sheet to be abnormal, the abnormal sheet is discharged to a discharge unit different from a discharge unit for normal sheets. In the purge mode, the printer 101 does not perform the recovery processing. The purge mode can be set in both the inline inspection and the offline inspection. As illustrated in FIG. 17A, the first to third sheets determined as normal sheets are discharged to the stack tray 341 in the purge mode. On the other hand, the fourth sheet determined as an abnormal sheet is discharged to the escape tray 346. The inspection apparatus 109 then inspects the fifth sheet. The fifth sheet, which is a normal sheet, is discharged to the stack tray 341. Eventually, the sheets corresponding to pages 1 to 3 and 5 are stacked on the stack tray 341, and only the sheet corresponding to page 4, which is an abnormal sheet, is stacked on the escape tray 346. In this manner, the printer 101 performs the purge processing in the purge mode.

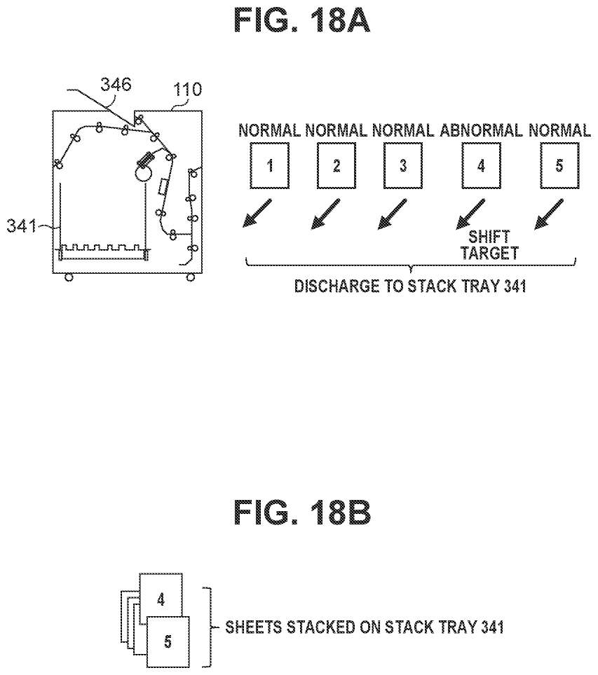

Next, the operation of the printer 101 in the shift mode will be described with reference to FIGS. 18A and 18B. FIGS. 18A and 18B illustrate sheet discharge destinations in the shift mode. The shift mode is a mode in which, in a case where the inspection apparatus 109 determines a sheet to be abnormal, the abnormal sheet is discharged to a position shifted by a predetermined amount from the position of normal sheets. In the shift mode, the printer 101 does not perform the recovery processing. The shift mode can be set in both the inline inspection and the offline inspection. As illustrated in FIG. 18A, in the shift mode, the first to fifth sheets are discharged to the stack tray 341 regardless of whether there is an abnormal sheet. At this time, the fourth sheet, which is an abnormal sheet, is discharged to a position shifted from the position of the first to third sheets, which are normal sheets, by a predetermined amount, for example, in a direction perpendicular to a conveyance direction. Eventually, the first to fifth sheets corresponding to pages 1 to 5 are stacked on the stack tray 341 with only the fourth sheet, which is an abnormal sheet, shifted from the other sheets. The foregoing processing in which an abnormal sheet is discharged to a position shifted by a predetermined amount from the position of normal sheets is referred to as “shift processing”.

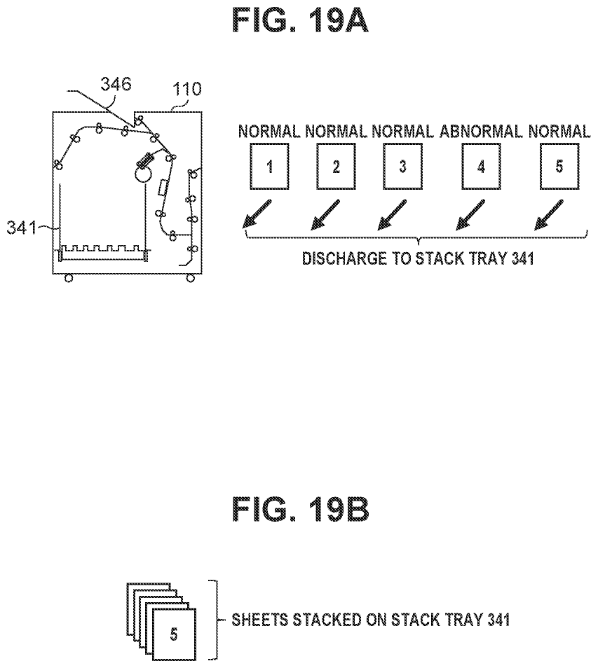

Next, the operation of the printer 101 in the log-only mode will be described with reference to FIGS. 19A and 19B. FIGS. 19A and 19B illustrate sheet discharge destinations in the log-only mode. The log-only mode is a mode in which, in a case where the inspection apparatus 109 determines a sheet to be abnormal, the abnormal sheet is discharged similarly to normal sheets, and only information about the abnormal sheet is logged. In the log-only mode, the printer 101 does not perform the recovery processing. The log-only mode can be set in both the inline inspection and the offline inspection. As illustrated in FIG. 19A, in the log-only mode, the first to fifth sheets are discharged to the stack tray 341 regardless of whether there is an abnormal sheet. Eventually, the first to fifth sheets corresponding to pages 1 to 5 are stacked as a complete set including the fourth sheet, which is an abnormal sheet, on the stack tray 341. The foregoing processing in which the printer 101 discharges an abnormal sheet without differentiating the discharge control on the abnormal sheet from the discharge control on normal sheets and logs information about the abnormal sheet is referred to as “log-only processing”.

In the above-described four operation modes, i.e., the purge-and-recovery mode, the purge mode, the shift mode, and the log-only mode, the inspection apparatus 109 logs information about the abnormal sheet, and the user can view inspection results via the display 241. In the examples illustrated in FIGS. 16A to 19B, since the fourth sheet is an abnormal sheet, the CPU 238 of the inspection apparatus 109 logs information indicating that the fourth sheet is an abnormal sheet in the memory 239.

### <Setting of Productivity in Job>

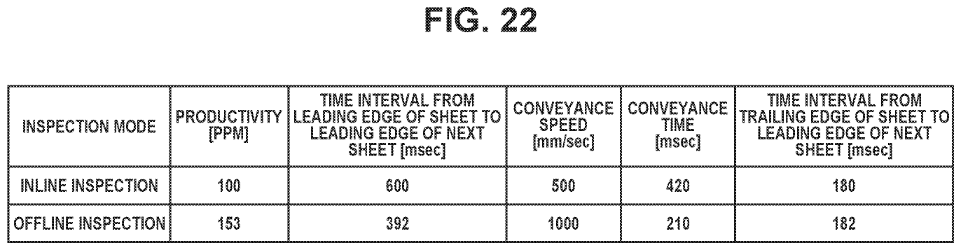

Next, productivity of the printer 101 in executing an inspection job will be described with reference to FIG. 22. FIG. 22 is a table illustrating the productivity and conveyance speed of the printer 101 in each of the inline inspection and the offline inspection. In the present exemplary embodiment, productivity (or throughput) refers to the number of sheets processed per predetermined time by an apparatus. More specifically, the productivity of the printing apparatus 107 is the number of sheets (the number of images) printable by the printing apparatus 107 during a predetermined time. The productivity of the inspection apparatus 109 is the number of sheets (the number of images) inspected by the inspection apparatus 109 during a predetermined time.

In the printer 101 according to the present exemplary embodiment, the printing apparatus 107, the inserter 108, the inspection apparatus 109, and the large-capacity stacker 110 are connected. In a case where the productivity of the printing apparatus 107 is lower than the productivity of the inspection apparatus 109, the inspection apparatus 109 desirably performs an inspection in accordance with the productivity of the printing apparatus 107. This prevents the inspection apparatus 109 from consuming excessive power. In the offline inspection, however, since the printing apparatus 107 does not perform printing, it is unnecessary for the inspection apparatus 109 to perform an inspection in accordance with the productivity of the printing apparatus 107. Thus, the inspection apparatus 109 according to the present exemplary embodiment is controlled to be higher in productivity in the offline inspection than in the inline inspection.

More specifically, as illustrated in the table of FIG. 22, the productivity of the printer 101 in the inline inspection is set at 100 pages per minute (ppm). This is because the productivity of the printing apparatus 107, which is a rate-determining factor for the printer 101, in the inline inspection is 100 ppm. In a case where the productivity of the printer 101 is 100 ppm, a time interval from the leading edge of a sheet to the leading edge of the next sheet is 600 milliseconds (msec). Thus, the inspection apparatus 109 is to perform the processing of conveying a sheet and inspecting the sheet within 600 msec. In the present exemplary embodiment, the conveyance speed of the entire printer 101 (the printing apparatus 107, the inserter 108, the inspection apparatus 109, and the large-capacity stacker 110) in the inline inspection is set at 500 millimeters per second (mm/s or mm/sec). In this case, it takes 420 msec for the printer 101 to convey an A4-size sheet (with a length of 210 mm), and a time interval from the trailing edge of the sheet to the leading edge of the next sheet is 180 msec. Thus, the inspection apparatus 109 can perform inspection processing of comparing a read image and a correct image and determining whether an image on a sheet is normal within 180 msec.

In the offline inspection, since there is no rate-determining factor due to the printing apparatus 107, the productivity of the printer 101 is set at 153 ppm. In a case where the productivity of the printer 101 is 153 ppm, the time interval from the leading edge of a sheet to the leading edge of the next sheet is approximately 392 msec. Thus, the inspection apparatus 109 is to perform the processing of conveying a sheet and inspecting the sheet within 392 msec. In the present exemplary embodiment, the conveyance speed of the inserter 108, the inspection apparatus 109, and the large-capacity stacker 110 in the offline inspection is set at 1000 mm/s. In this case, it takes 210 msec for the inserter 108, the inspection apparatus 109, and the large-capacity stacker 110 to convey an A4-size sheet, and the time interval from the trailing edge of the sheet to the leading edge of the next sheet is 182 msec. Thus, the inspection apparatus 109 can perform the inspection processing within 182 msec. As described above, according to the present exemplary embodiment, the conveyance speed (a second conveyance speed) of the printer 101 in the offline inspection is set at a value faster than a value of the conveyance speed (a first conveyance speed) of the printer 101 in the inline inspection. This enables the productivity (second throughput) of the inspection apparatus 109 in the offline inspection to be made higher than the productivity (first throughput) of the inspection apparatus 109 in the inline inspection. The productivity and the conveyance speeds of the printer 101 are not limited to the above-described values and can be set appropriately depending on job conditions and/or apparatus specifications.

### <Operation of Image Forming Apparatus>

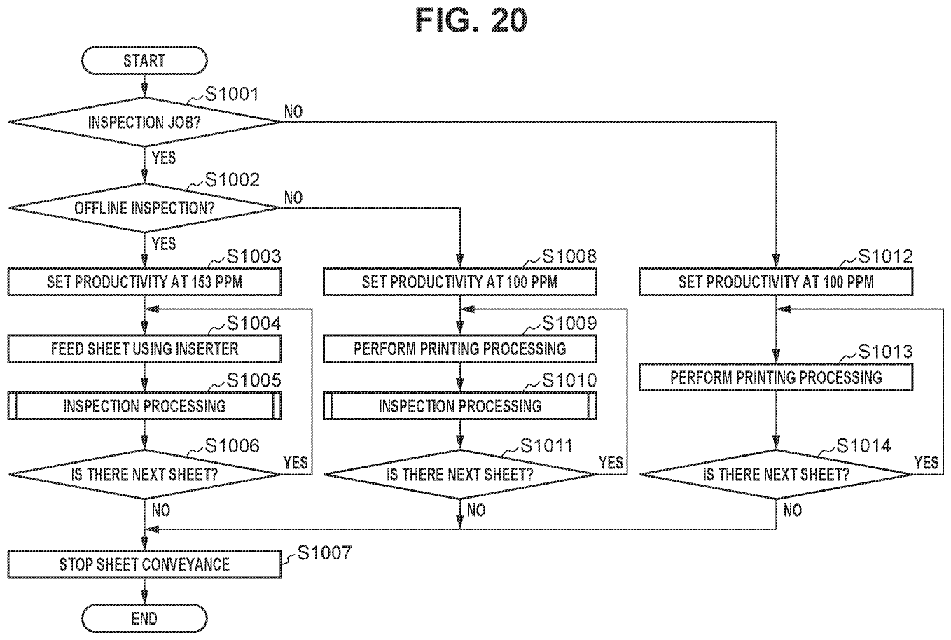

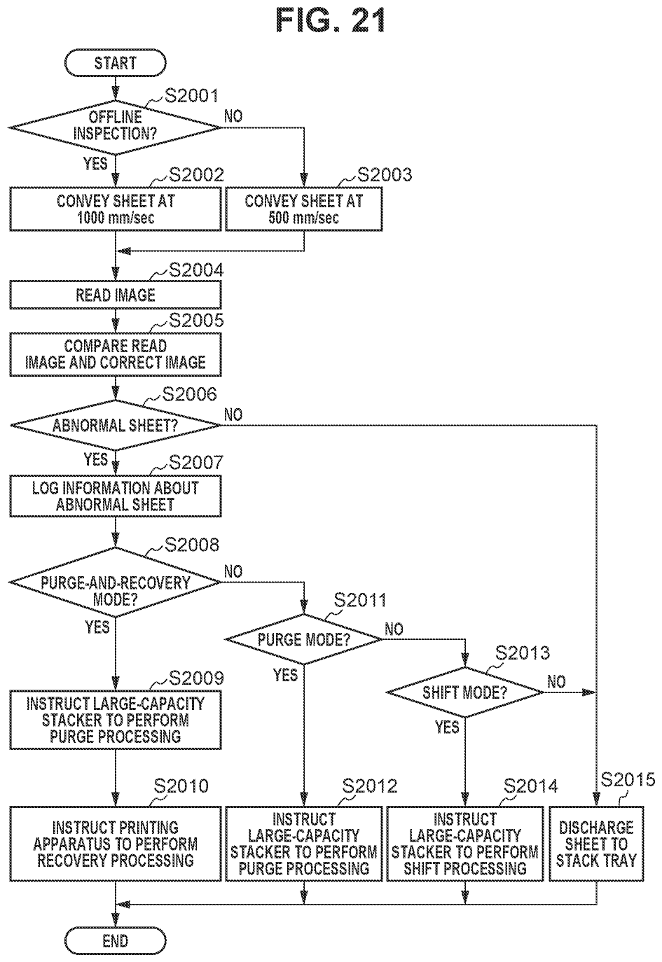

Next, an operation of the printer 101 in executing a job will be described with reference to FIGS. 20 and 21. FIG. 20 is a flowchart illustrating the operation of the printer 101 in executing a job. FIG. 21 is a flowchart illustrating an operation of the inspection apparatus 109 in performing the inspection processing.

In step S1001, in a case where the user issues an instruction to start a job to the printer 101 from the client PC 103 via the external controller 102, the CPU 222 determines whether the job submitted from the client PC 103 is an inspection job for which the inspection apparatus 109 is to perform an inspection. In a case where the job submitted from the client PC 103 is an inspection job (YES in step S1001), the processing proceeds to step S1002. In step S1002, the CPU 222 refers to information about the job and the inspection mode setting recorded in the memory 223 and determines whether the inspection mode is the offline inspection. In a case where the inspection mode is the offline inspection (YES in step S1002), the processing proceeds to step S1003. In step S1003, the CPU 222 sets the productivity at 153 ppm. More specifically, as described above, the conveyance speed of the inserter 108, the inspection apparatus 109, and the large-capacity stacker 110 is set at 1000 mm/s.

In step S1004, the inserter 108 starts feeding a sheet based on an instruction from the CPU 222. In step S1005, the inspection apparatus 109 performs the inspection processing on the sheet fed by the inserter 108. The operation of the inspection apparatus 109 in performing the inspection processing will be described below. In a case where there is a next sheet (YES in step S1006), the processing returns to step S1004 to repeat the sheet feeding by the inserter 108 and the inspection processing by the inspection apparatus 109. In a case where the inspection processing is completed on all sheets (NO in step S1006), the processing proceeds to step S1007. In step S1007, the CPU 222 instructs the inserter 108, the inspection apparatus 109, and the large-capacity stacker 110 to stop the sheet conveyance. The CPU 222 then ends the processing in the flowchart.

In a case where the inspection mode is the inline inspection (NO in step S1002), the processing proceeds to step S1008. In step S1008, the CPU 222 sets the productivity at 100 ppm. More specifically, as described above, the conveyance speed of the printing apparatus 107, the inserter 108, the inspection apparatus 109, and the large-capacity stacker 110 is set at 500 mm/s.

In step S1009, the printing apparatus 107 feeds a sheet stored in the sheet feed deck 301 or 302 and performs the above-described printing processing on the fed sheet. In step S1010, the inspection apparatus 109 performs the inspection processing on the sheet with an image formed thereon by the printing apparatus 107. In a case where there is a next sheet (YES in step S1011), the processing returns to step S1009 to repeat the printing processing by the printing apparatus 107 and the inspection processing by the inspection apparatus 109. In a case where the inspection processing is completed on all sheets (NO in step S1011), the processing proceeds to step S1007. In step S1007, the CPU 222 instructs the printing apparatus 107, the inserter 108, the inspection apparatus 109, and the large-capacity stacker 110 to stop the sheet conveyance. The CPU 222 then ends the processing in the flowchart.

In a case where the job submitted from the client PC 103 is not an inspection job (NO in step S1001), the processing proceeds to step S1012. In step S1012, the CPU 222 sets the productivity at 100 ppm.

More specifically, as described above, the conveyance speed of the printing apparatus 107, the inserter 108, the inspection apparatus 109, and the large-capacity stacker 110 is set at 500 mm/s. In the present example, the sheet conveyance speed in the print mode in which only the printing is performed is set to the same value as the value of the conveyance speed in the inline inspection. In step S1013, the CPU 222 repeats the printing processing by the printing apparatus 107 as long as there is a next sheet (YES in step S1014). In a case where the printing processing is completed on all sheets (NO in step S1014), the processing proceeds to step S1007. In step S1007, the CPU 222 ends the processing in the flowchart.

Next, the operation of the inspection apparatus 109 in the inspection processing in steps S1005 and S1010 will be described with reference to FIG. 21. The CPU 238 of the inspection apparatus 109 performs the inspection processing in the flowchart in FIG. 21 based on an instruction from the CPU 222.

In step S2001, when the inspection processing is started, the CPU 238 determines whether the inspection mode is the offline inspection based on information transmitted from the CPU 222. In a case where the inspection mode is the offline inspection (YES in step S2001), the processing proceeds to step S2002. In step S2002, the sheet conveyed from the inserter 108 is conveyed at a conveyance speed of 1000 mm/s. In a case where the inspection mode is the inline inspection (NO in step S2001), the processing proceeds to step S2003. In step S2003, the sheet conveyed from the inserter 108 is conveyed at a conveyance speed of 500 mm/s.

In step S2004, the CPU 238 reads an image on the conveyed sheet using the reading unit 331 or 332. In step S2005, the CPU 238 compares the image read in step S2004 and a pre-registered correct image and determines whether the image on the sheet is normal. In a case where the inspected sheet is an abnormal sheet (YES in step S2006), the processing proceeds to step S2007. In step S2007, the CPU 238 logs information about the abnormal sheet.

In step S2008, the CPU 238 determines whether the purge-and-recovery mode is set based on inspection setting information transmitted from the CPU 222. In a case where the purge-and-recovery mode is set (YES in step S2008), the processing proceeds to step S2009. In step S2009, the CPU 238 instructs the large-capacity stacker 110 to perform the purge processing. In step S2010, the CPU 238 instructs the printing apparatus 107 to perform the recovery processing of reprinting the image formed on the abnormal sheet on another sheet.

In a case where the purge-and-recovery mode is not set (NO in step S2008), the processing proceeds to step S2011. In step S2011, the CPU 238 determines whether the purge mode is set. In a case where the purge mode is set (YES in step S2011), the processing proceeds to step S2012. In step S2012, the CPU 238 instructs the large-capacity stacker 110 to perform the purge processing.

In a case where the purge mode is not set (NO in step S2011), the processing proceeds to step S2013. In step S2013, the CPU 238 determines whether the shift mode is set. In a case where the shift mode is set (YES in step S2013), the processing proceeds to step S2014. In step S2014, the CPU 238 instructs the large-capacity stacker 110 to perform the shift processing.

In a case where the shift mode is not set (NO in step S2013) or the sheet inspected by the inspection apparatus 109 is a normal sheet (NO in step S2006), the processing proceeds to step S2015. In step S2015, the CPU 238 instructs the large-capacity stacker 110 to discharge the sheet to the stack tray 341 as usual.

The foregoing control enables the printer 101 to perform the inline inspection and the offline inspection.

As described above, the printer 101 according to the present exemplary embodiment executes a job at higher productivity in a case where the inspection mode is the offline inspection than in a case where the inspection mode is the inline inspection. In other words, the number of sheets (images) that can be inspected by the inspection apparatus 109 during a predetermined time is greater in the offline inspection than in the inline inspection. This enables the printer 101 to execute a job at appropriate productivity in each of the inline inspection and the offline inspection, and especially the productivity in the offline inspection can improve.

The printer 101 according to the above-described exemplary embodiment controls the productivity in the offline inspection to be higher than the productivity in the inline inspection by setting the conveyance speed in the offline inspection to be higher than the conveyance speed in the inline inspection. Alternatively, the printer 101 can control the productivity to be higher in the offline inspection than in the inline inspection by setting an interval between sheets in the inserter 108 and the inspection apparatus 109 in the offline inspection to be smaller than the interval between sheets in the inline inspection.

The exemplary embodiment according to the present disclosure can prevent a decrease in productivity of an image forming system capable of performing both an inline inspection and an offline inspection.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-089387, filed Jun. 1, 2022, which is hereby incorporated by reference herein in its entirety.

What is claimed is:

1. An image forming system comprising:
an image forming apparatus configured to form an image on a sheet;
an inspection apparatus configured to read an image on a sheet and inspect the read image;
a conveyance apparatus disposed between the image forming apparatus and the inspection apparatus and including a stack tray on which a sheet is to be stacked, the conveyance apparatus being configured to convey the sheet discharged from the image forming apparatus and the sheet stacked on the stack tray to the inspection apparatus; and
a control unit configured to perform a first inspection mode in which the sheet on which the image is formed by the image forming apparatus and which is discharged from the image forming apparatus is conveyed to the inspection apparatus and inspected by the inspection apparatus and a second inspection mode in which the sheet stacked on the stack tray of the conveyance apparatus is conveyed to the inspection apparatus and inspected by the inspection apparatus,
wherein a number of sheets inspected by the inspection apparatus during a predetermined time is greater in the second inspection mode than in the first inspection mode.

2. The image forming system according to claim 1, wherein a sheet conveyance speed of the conveyance apparatus in the second inspection mode is faster than a sheet conveyance speed of the conveyance apparatus in the first inspection mode.

3. The image forming system according to claim 2,
wherein the control unit is configured to perform a print mode in which the image forming apparatus forms the image on the sheet and the inspection apparatus does not inspect the image on the sheet, and
wherein a sheet conveyance speed of the conveyance apparatus in the print mode is equal to the sheet conveyance speed of the conveyance apparatus in the first inspection mode.

4. The image forming system according to claim 1, wherein an interval between consecutive sheets conveyed by the conveyance apparatus is smaller in the second inspection mode than in the first inspection mode.

5. The image forming system according to claim 1, further comprising a discharge apparatus including a first discharge tray to which a sheet is to be discharged and a second discharge tray to which a sheet is to be discharged,
wherein the discharge apparatus is configured to discharge, to the first discharge tray, a sheet with an image determined to be normal by the inspection apparatus and discharge, to the second discharge tray, a sheet with an image determined to be abnormal by the inspection apparatus.

6. The image forming system according to claim 1, wherein the conveyance apparatus is an inserter configured to insert an insert sheet into a plurality of sheets each having an image formed thereon by the image forming apparatus.

7. An inspection apparatus configured to read an image on a sheet and inspect the read image and connected downstream of an image forming apparatus configured to form an image on a sheet and a conveyance apparatus configured to convey a sheet, the inspection apparatus comprising:
a control unit configured to perform a first inspection mode in which the sheet on which the image is formed by the image forming apparatus and which is discharged from the image forming apparatus is conveyed to the inspection apparatus and inspected by the inspection apparatus and a second inspection mode in which a sheet stacked on a stack tray of the conveyance apparatus is conveyed to the inspection apparatus and inspected by the inspection apparatus,
wherein a number of sheets inspected by the inspection apparatus during a predetermined time is greater in the second inspection mode than in the first inspection mode.
